(19) United States
(12) Patent Application Publication
(10) Pub. No.: US 2006/0009565 A1
(43) Pub. Date: Jan. 12, 2006

(54) Phosphorescent pigment mixtures and dispersions

(75) Inventors: Larry Lee Lough, Springdale, OH (US); Dennis Dean Loyd, West Chester, OH (US)

Correspondence Address: Schwegman, Lundberg, Woessner & Kluth, P.A., P.O. Box 2938, Minneapolis, MN, 55402, US

(73) Assignee: Tri E Holding, LLC

(21) Appl. No.: 11/217,783

(22) Filed: Aug. 31, 2005

Related U.S. Application Data
(63) Continuation-in-part of application No. 10/723,017, filed on Nov. 26, 2003.

(51) Int. Cl. C09K 11/02; C08K 3/34

(52) U.S. Cl. 524/442; 252/301.35

(57) ABSTRACT

Phosphorescent pigment mixtures and techniques for dispersion of phosphorescent pigments are provided. A phosphorescent mixture includes a doped aluminum silicate phosphorescent pigment material, a dispersant material, a resin, and a liquid carrier material. In an embodiment, the doped aluminum silicate phosphorescent pigment particles are mixed with liquid solutions of a product, and the resulting product may be applied to a substrate. The phosphorescent particles are suspended or mixed in the liquid solutions at diameter sizes of approximately 5 microns or less.

### RELATED MATTERS

The present application claims priority to and is a Continuation-In Part of U.S. application Ser. No. 10/723,017, filed on Nov. 26, 2003, and entitled “Methods for Coating Substrate,” the disclosure of which is incorporated by reference herein.

### FIELD

The invention relates generally to phosphorescent pigments and more particularly to phosphorescent pigment mixtures and techniques for dispersion of phosphorescent pigments.

### BACKGROUND

Typically, phosphorescent pigments are either based on Zinc Sulphide or Stontium Aluminate chemistries. While these pigments have been used for a number of years and in a variety of applications, it has been difficult to incorporate these materials into fluid based materials, such as paints, inks, and the like. This is so, because conventional phosphorescent pigments have high densities and very specific processing parameters, which make it tough to integrate these conventional phosphorescent pigments into fluid-based materials.

That is, conventional phosphorescent pigments have high specific gravities and are often acquired in large particle sizes. These attributes make it difficult to properly and efficiently disperse conventional phosphorescent pigments into various materials and limit the applications of conventional phosphorescent pigments.

Still, phosphorescent paints have been attempted but with limited success. These paints are not capable of adequately absorbing ultraviolet (UV) light and maintaining an acceptable level of luminescence or intensity. To remedy this a variety of workaround techniques have been attempted, such as requiring a base white paint to be coated or primed onto a substrate before the phosphorescent paint is applied in an effort to provide better UV absorption and longer luminescence for the applied phosphorescent paint.

Moreover, because of the high specific gravity and ionic attraction of phosphorescent particles most phosphorescent paints are difficult to effectively apply to a substrate because the phosphorescent particles accumulate on the brush, roller, and/or applicator mechanism used to apply the paint. The result is a diluted having less than desired phosphorescent pigment that is distributed on the substrate.

Therefore, improved phosphorescent pigments and improved dispersion techniques for phosphorescent pigments are needed.

### SUMMARY

In various embodiments, a phosphorescent dispersion mixture is provided. The phosphorescent dispersion mixture includes a doped aluminum silicate phosphorescent pigment material, a dispersant material, a resin material, and a liquid carrier material. In an embodiment, the liquid carrier material is further mixed with paint, ink, or plastic. The phosphorescent pigment material is included in the mixture at reduced particle sizes of 5 microns or less in diameter. In some embodiments, the diameter sizes of the phosphorescent pigment material are approximately 1 micron or less.

### BRIEF DESCRIPTION OF THE DRAWINGS

FIG. 1 is a diagram of a phosphorescent dispersion mixture, according to an example embodiment.

FIG. 2 is a diagram or a method for dispersing a phosphorescent mixture in a liquid solution of a product, according to an example embodiment.

FIG. 3 is a diagram of a phosphorescent dispersion system, according to an example embodiment.

### DETAILED DESCRIPTION

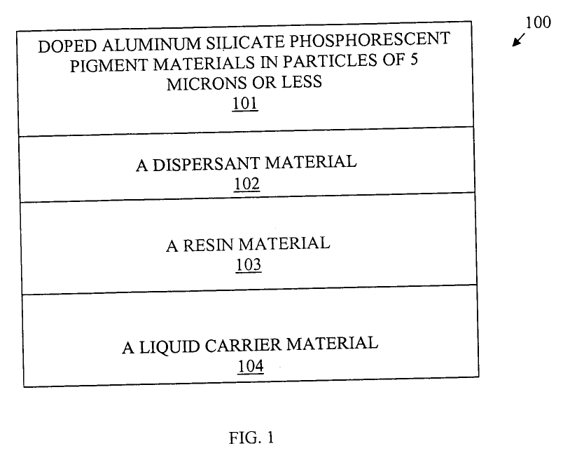

FIG. 1 is a diagram of a phosphorescent dispersion mixture 100, according to an example embodiment. The phosphorescent dispersion mixture 100 includes an aluminum silicate phosphorescent dispersion material 101, a dispersant material 102, a resin material 103, and a liquid carrier material 104.

Aluminum silicate (Al₂SiO₄) 101 is doped and includes phosphorescent characteristics and is referred to herein as “doped aluminum silicate phosphorescent pigment material” 101. The doped aluminum silicate phosphorescent pigment material 101, when excited by Ultraviolet (UV) radiation, such as light, glows in the dark or emits light in the dark.

The doped aluminum silicate phosphorescent pigment material 101 is acquired in solid form as particles. The particles have diameter sizes of approximately 5 microns or less. In an embodiment, the particle diameter sizes are approximately 1 micron. At these small particle sizes, the particles will remain suspended and dispersed in the liquid carrier material 104 without a tendency to accumulate with one another. This provides a more uniform distribution of the particles within the mixture 100.

In an embodiment, the doped aluminum silicate phosphorescent pigment material 101 is mechanically ground and classified into sizes of 5 microns or less using pulverizing techniques, grinders, screens, and/or filtering techniques to acquire the crushed particles at the desired small sizes.

The phosphorescent mixture 100 also includes a dispersant material 102. The dispersants can be anionic, cationic, or amphoteric. The dispersant material 102 may also be ethoxylates, sulfonates, phosphates, and the like.

A resin material 103 is also included in the phosphorescent mixture 100. The resin material 103 is a low molecular resin material 103 having a molecular weight or approximately 500 to 25,000 and having a great affinity for the doped aluminum silicate phosphorescent pigment material 101.

The phosphorescent mixture 100 also includes a liquid carrier material 104. The liquid carrier material 104 may include water, aliphatic and aromatic hydrocarbons or any other solvent-based liquid.

The materials 101-104 of the phosphorescent mixture 100 are combined to form slurry. Any mechanical mixing technique may be used to mix the materials 101-104 with one another. The resulting slurry is the phosphorescent mixture 100.

In an embodiment, the phosphorescent mixture 100 may be formulated to be a universal dispersion, such that it can be incorporated and/or mixed with a multitude of other solvents or resin systems. Additionally, the phosphorescent mixture 100 can be manufactured for water-based formulas with various types of resins 103, such as acrylics, urethanes, epoxies, and/or alkyds. This is beneficial because commercial paint which is largely oil-based is flammable and new emerging standards are requiring the paints to be non-flammable and water-based. The mixture presented herein stays suspended and mixed in water-based paints providing a novel benefit over what has been conventionally achieved with phosphorescent pigment-based paints in the past.

According to an embodiment, the doped aluminum silicate phosphorescent pigment material 101 is produced by Visionglow LLC, of Australia. It is however to be understood that any doped aluminum silicate phosphorescent pigment material 101 may be used with the phosphorescent mixtures 100 presented herein and that the one produced by Visionglow is presented for purposes of illustrating an example doped aluminum silicate phosphorescent pigment material 101 having a favorable particle size of 5 microns or less and in some cases approximately 1 micron.

Each of the materials 101-104 maybe optionally concentrated within the resulting phosphorescent dispersion mixture 100 at desired ratios. For example and according to an embodiment, the doped aluminum silicate phosphorescent pigment material 101 may be concentrated within the mixture 100 at approximately a 40-70% ratio; the dispersant material 102 concentrated within the mixture 100 at approximately a 1-10% ratio; the resin material 103 concentrated within the mixture 100 at approximately a 1-40% ration; and the liquid carrier material concentrated within the mixture 100 at approximately a 1-50% ratio.

The novel phosphorescent mixture 100 may subsequently be combined with other products or solvents, such as paints, inks, and/or plastics. These products may then also be applied to other substrates, such as walls, etc. for purposes of exhibiting luminescent characteristics. Application of the products having the phosphorescent mixture 100 does not result in conventional problems because the aluminum silicate phosphorescent dispersion material 101 within the mixture 100 does not accumulate or attract in the manner that is exhibited by conventional formulations. The result is a doped aluminum silicate phosphorescent pigment material 101 that is more uniformly dispersed within the mixture 100 and thus the product to which it is subsequently mixed with. The phosphorescent characteristics and pigments are then more concentrated and affixed to the substrates on which they are applied in more evenly distributed manner. A more diffuse and even distribution of the phosphorescent material 101 on a substrate permits more UV radiation to be absorbed by the doped aluminum silicate phosphorescent pigment material 101, which creates a better charge. Accordingly, the novel phosphorescent dispersion mixture 100 results in improved luminescence and improved application of solvents having the mixture 100 integrated therein.

In some formulations of the mixture 100, a colorant may be added for purposes of producing a desired color, which is emitted by the mixture 100. For example, the color red may be added to the mixture using red color phosphorescent pigment. Other colors may be configured or integrated into the mixture 100 as well, such as but not limited to, blue, purple, green, etc.

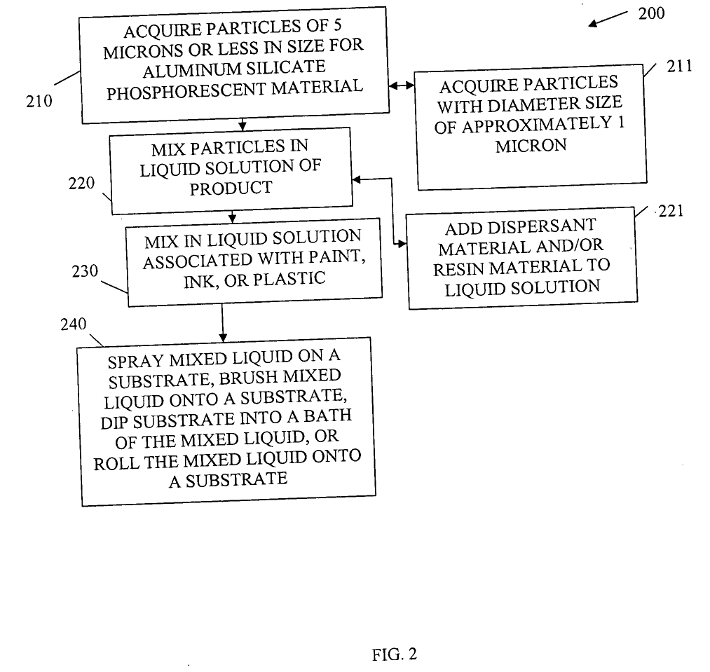

FIG. 2 is a diagram or a method 200 for dispersing phosphorescent mixtures in a liquid solution of a product, according to an example embodiment. The method 200 may be practiced in fabrication environments using equipment known to one of ordinary skill in the art in the pigment and phosphorescent arts. In an embodiment, the phosphorescent mixture is the mixture 100 described above with respect to the FIG. 1.

At 210, particles of doped aluminum silicate phosphorescent pigment material are acquired in diameter sizes of approximately 5 microns or less. In an embodiment, at 211, the diameter sizes are approximately 1 micron. In some cases, the doped aluminum silicate phosphorescent pigment material may be acquired in a mixture or slurry form, which has the particles of the desired sizes, such as the mixture 100 described in the FIG. 1 above.

At 220, the acquired particles of doped aluminum silicate phosphorescent pigment material are mixed in a liquid solution or form of a product. The doped aluminum silicate pigment material is mixed as a slurry and mixture, such as the mixture 100 described in FIG. 1 above.

According to an embodiment, at 230, the mixing with the liquid solution may occur with a product that is paint, ink, and/or plastic. That is the product may be in a liquid form in its native state, such as paint or ink. Alternatively, the product may be melted into a liquid form during its fabrication and subsequently acquire a different state, such as a plastic would acquire a native solid state after molded into its desired form.

In still another embodiment, at 240, the resulting liquid version of the product having the dispersed particles of doped aluminum silicate phosphorescent pigment material may be further spayed onto another substrate, brushed onto the substrate, or rolled onto the substrate. In still other situations, at 240, the substrate may be dipped into a bath of the liquid that has the particles of doped aluminum silicate phosphorescent pigment material. The substrate will exhibit enhanced luminescence capabilities that better absorb UV radiation and better emit light in darkness or low lit environments. These embodiments are useful when the product is in a native liquid form, such as paints or inks, and is applied to another substrate or product, such as paper, clothing, building materials, electronics, etc.

Example applications of the above presented technique for dispersing phosphorescent materials are numerous. For example, consider emergency exits associated with vehicles, aircraft, vessels, or buildings; these structures can have emergency exits and pathways to the emergency exits painted with a paint (liquid version of a product) that includes the particles of aluminum silicate phosphorescent material or the mixture 100 of FIG. 1. The result is an enhanced lighting environment in these structures when power is lost or darkness sets in; thereby providing improved safety for the occupants of these structures. Of course a variety of other applications are possible, such as coating roadways, integrating the particles of doped aluminum silicate phosphorescent pigment material into building materials, clothing materials, appliances, electronics, and the like. All such applications that include the particles of doped aluminum silicate phosphorescent pigment material are intended to fall within the scope of the embodiments presented herein.

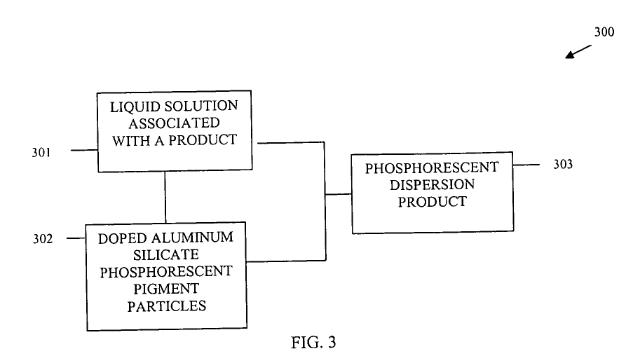

FIG. 3 is a diagram of a phosphorescent dispersion system 300, according to an example embodiment. The system 300 may be practiced by the method 200 of FIG. 2 and may include the mixtures 100 of FIG. 1.

The phosphorescent dispersion system 300 includes a liquid solution associated with a product 301 and doped aluminum silicate phosphorescent pigment particles 302. The liquid solution 301 and the doped aluminum silicate phosphorescent pigment particles 302 are mixed and integrated with one another to produce a phosphorescent dispersion-enhanced product 303. The product 303 exhibits improved absorption of UV radiation or energy, includes doped phosphorescent pigment particles 302 more evenly dispersed throughout the product 303, and exhibits enhanced luminescence by emitting more light in low lit environments or in darkness.

In an embodiment, the liquid version of the product 301 is a paint mixture, an ink mixture, or a plastic mixture. In some other embodiments, the liquid version of the product 301 may include rubbers, metals, or other materials that have been liquefied during a fabrication process. That is, the liquid version of the product 301 may be natively in a liquid state or may be made into a liquid state for purposes of fabrication.

According to an embodiment, the doped aluminum silicate phosphorescent pigment particles 302 are manufactured such that each particle has a diameter size of 5 microns or less. In one embodiment, the diameter size of the doped aluminum silicate phosphorescent pigment particles 302 is approximately 1 micron.

In some cases, other additives may be added to the doped aluminum silicate phosphorescent pigment particles 302. That is, additives may provide better diffusion and integration of the doped aluminum silicate phosphorescent pigment particles 302 and/or may provide different characteristics to the resulting product to which it is applied. These additives may be directly integrated with the doped aluminum silicate phosphorescent pigment particles 302 to form mixtures or slurries, such as the mixture 100 of FIG. 1. Some example additives were discussed above with FIG. 1 and can include, but are not limited to, resin materials having low molecular weights, colorants, aromatics, dispersant materials, and/or liquid carrier materials.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A phosphorescent dispersion mixture, comprising:
a doped aluminum silicate phosphorescent pigment material broken into a plurality of particles, each particle having a diameter size of approximately 5 microns or less;
a dispersant material;
a resin material; and
a liquid carrier material;
wherein the particles, the dispersant material, and the resin material are combined in the liquid carrier material to form a slurry and mixed together to form the phosphorescent dispersion mixture.

2. The phosphorescent dispersion mixture of claim 1, wherein the dispersant material is at least one of anionic, cationic, and amphoteric.

3. The phosphorescent dispersion mixture of claim 1, wherein the dispersant material is at least one of an ethoxlate, a sulfonate, and a phosphate.

4. The phosphorescent dispersion mixture of claim 1, wherein the resin material has a molecular weight of approximately 500 to 25,000.

5. The phosphorescent dispersion mixture of claim 1, wherein the phosphorescent dispersion mixture is formulated as a universal dispersion material.

6. The phosphorescent dispersion mixture of claim 1 further comprising at least one of water and aliphatic and aromatic hydrocarbons.

7. The phosphorescent dispersion mixture of claim 1, wherein the resin material is at least one of an acrylic material, a urethane material, an epoxy material, and an alkyd material.

8. The phosphorescent dispersion mixture of claim 1, wherein the phosphorescent dispersion mixture includes approximately 40-70% of the doped aluminum phosphorescent pigment material, approximately 1-10% of the dispersant material, approximately 1-40% of the resin material, and approximately 1-50% of the liquid carrier material.

9. The phosphorescent dispersion mixture of claim 1, wherein the particles have diameter sizes of approximately 1 micron.

10. A method, comprising:
acquiring particles of doped aluminum silicate phosphorescent pigment material in diameter sizes of approximately five microns or less; and
mixing the particles in a liquid solution associated with a product.

11. The method of claim 10, wherein acquiring further includes acquiring the particles having diameter sizes of approximately 1 micron.

12. The method of claim 10, wherein mixing further includes mixing the particles in the product, wherein the product is at least one of a paint mixture, an ink mixture, and a plastic mixture.

13. The method of claim 10, wherein mixing further includes adding at least one of a dispersant material and a resin material with the particles before mixing.

14. The method of claim 10 further comprising at least one of:
spraying the liquid version of the product having the particles on a substrate;
brushing the liquid version of the product having the particles on the substrate;
dipping the substrate into a bath of the liquid version of the product having the particles; and
rolling the liquid version of the product having the particles onto the substrate.

15. The method of claim 10 further comprising, packaging the liquid version of the product having the particles.

16. A system, comprising:
a liquid solution associated with a product; and
doped aluminum silicate phosphorescent pigment particles, wherein the doped aluminum silicate phosphorescent pigment particles are adapted to be mixed in the liquid solution to produce a phosphorescent liquid solution for the product, and wherein each particle has a diameter size of approximately 5 microns or less.

17. The system of claim 16, wherein the product is at least one of paint mixture, an ink mixture, and a plastic mixture.

18. The system of claim 16, wherein each of the doped aluminum silicate phosphorescent pigment particles have an approximate diameter size of 1 micron.

19. The system of claim 16, wherein the particles are mixed with a resin material having a low molecular weight.

20. The system of claim 19, wherein the particles are mixed with a dispersant material.
